(19) United States
(12) Patent Application Publication
(10) Pub. No.: US 2016/0091717 A1
(43) Pub. Date: Mar. 31, 2016

(54) HEAD-MOUNTED DISPLAY SYSTEM AND OPERATION METHOD THEREOF

(71) Applicant: Coretronic Corporation, Hsin-Chu (TW)

(72) Inventors: Chia-Chien Wu, Hsin-Chu (TW); Chien-Ting Chen, Hsin-Chu (TW); Fu-Yu Hsu, Hsin-Chu (TW); Chi-Wu Hsiao, Hsin-Chu (TW)

(21) Appl. No.: 14/746,846

(22) Filed: Jun. 23, 2015

(30) Foreign Application Priority Data
Sep. 25, 2014 (TW) 103133227

(51) Int. Cl. G02B 27/01; G02B 27/64

(52) U.S. Cl. CPC G02B 27/017; G02B 27/646; G02B 2027/0178; G02B 27/0093

(57) ABSTRACT

A display system and an operation method thereof are provided. The head-mounted display (HMD) device of the display system includes a camera, a monitor, a communication circuit and a processor. The processor is coupled to the monitor, the camera and the communication circuit. The processor receives and processes sensing data provided by a motion sensor of the display system through the communication circuit, so as to obtain a motion trajectory of the user. The camera photographs a person in a view field of the user. The processor performs image recognition to the video data provided by the camera, so as to obtain a motion trajectory of the person. The processor controls the monitor to display the motion trajectory of the user or the motion trajectory of the person.

### CROSS-REFERENCE TO RELATED APPLICATION

This application claims the priority benefit of Taiwan application serial no. 103133227, filed on Sep. 25, 2014. The entirety of the above-mentioned patent application is hereby incorporated by reference herein and made a part of this specification.

### BACKGROUND

1. Technical Field

The invention relates to a display system, and particularly relates to a head-mounted display (HMD) system and an operation method thereof.

2. Related Art

Sport auxiliary facilities (for example, a golf swing training device) in the market generally use a small size liquid crystal display (LCD) or a smart phone to display motion guiding information (for example, user's motion posture or other information). The user often needs to stop a motion (for example, stops a swing motion) to take out the LCD (or the smart phone) from pocket or waist in order to view whether his motion posture (for example, the swing motion) is standard or correct, or learn inaccuracies in the motion posture for improvement. The user may feel inconvenient for frequently putting the LCD (or the smart phone) into the pocket or taking the LCD (or the smart phone) out of the pocket.

Relevant Patents and/or published patent applications may include China patent publication No. CN 103064188, CN 103543843, CN 103713737, U.S. patent No. US 2013/0214998, US 2013/0174205 and Taiwan patent publication No. TW M480407.

The information disclosed in this “BACKGROUND” section is only for enhancement understanding of the background of the invention and therefore it may contain information that does not form the prior art that is already known to a person of ordinary skill in the art. Furthermore, the information disclosed in this “BACKGROUND” section does not mean that one or more problems to be solved by one or more embodiments of the invention was acknowledged by a person of ordinary skill in the art.

### SUMMARY

The invention is directed to a display system and an operation method thereof, and a user is capable of photographing a person within a view field through a head-mounted display device, and the head-mounted display device is capable of displaying a motion trajectory of the user or a motion trajectory of the person that is photographed.

Other objects and advantages of the invention can be further illustrated by the technical features broadly embodied and described as follows.

In order to achieve one or a portion of or all of the objects or other objects, an embodiment of the invention provides a display system including a first motion sensor and a head-mounted display (HMD) device. The first motion sensor is adapted to be disposed on at least one of limbs of a user or an object held by the user. The head-mounted display device is adapted to be worn on a head of the user. The head-mounted display device includes a camera, a monitor, a communication circuit and a processor. The camera is adapted to photograph a person in a view field of the user to generate video data. The monitor is adapted to display an image for the user to view. The communication circuit is adapted to establish connection with the first motion sensor. The processor is coupled to the monitor, the camera and the communication circuit. The processor is adapted to receive and process first sensing data provided by the first motion sensor through the communication circuit, so as to obtain a motion trajectory of the user. The processor is adapted to receive the video data provided by the camera, and perform image recognition to the video data to obtain a motion trajectory of the person. The processor is adapted to control the monitor to display the motion trajectory of the user or the motion trajectory of the person.

In one embodiment, the motion trajectory of the user comprises a motion trajectory of the least one of limbs of the user or a motion trajectory of the object held by the user, and the motion trajectory of the person comprises a motion trajectory of at least one of limbs of the person or a motion trajectory of another object held by the person.

In one embodiment, the first motion sensor comprises a g-sensor, a gyroscope, an accelerometer, an electronic compass, or an altitude meter.

In one embodiment, the motion trajectory of the user and the motion trajectory of the person are simultaneously displayed on the image.

In one embodiment, the HMD device comprises a sound sensor. The sound sensor is coupled to the processor and adapted to sense a sound sent by the user to generate sound data to the processor. The processor is adapted to perform voice recognition to the sound data to obtain a sound control instruction.

In one embodiment, the HMD device comprises a touch sensor. The touch sensor is coupled to the processor and adapted to sense a touch operation of the user to generate touch data to the processor. The processor is adapted to generate a touch instruction according to the touch data.

In one embodiment, the HMD device comprises a second motion sensor. The second motion sensor is coupled to the processor and adapted to sense a head motion of the user to generate second sensing data to the processor.

In one embodiment, the second motion sensor comprises an electronic compass, a gyroscope, a geomagnetic sensor, an accelerometer, or a g-sensor.

In one embodiment, the processor is adapted to generate a menu instruction according to the second sensing data.

In one embodiment, the processor is adapted to correct the motion trajectory of the person according to a direction of the person in the video data.

In order to achieve one or a portion of or all of the objects or other objects, an embodiment of the invention provides an operation method of a display system, which includes following steps: sensing a motion of a user to generate first sensing data by a first motion sensor; analyzing the first sensing data transmitted to a processor of a head-mounted display device from the first motion sensor by the processor to obtain a motion trajectory of the user; photographing a person in a view field of the user by a camera of the head-mounted display device, so as to provide video data and transmit the video data to the processor; performing image recognition to the video data to obtain a motion trajectory of the person by the processor; and displaying the motion trajectory of the user or the motion trajectory of the person on an image by a monitor of the HMD device.

In one embodiment, the HMD device is adapted to be worn on a head of the user, the first motion sensor is adapted to be disposed on at least one of limbs of the user or on an object held by the user, and the motion trajectory of the user comprises a motion trajectory of the least one of limbs of the user or a motion trajectory of the object held by the user.

In one embodiment, the motion trajectory of the person comprises a motion trajectory of at least one of limbs of the person or a motion trajectory of another object held by the person.

In one embodiment, the first motion sensor comprises a g-sensor, a gyroscope, an accelerometer, an electronic compass, or an altitude meter.

In one embodiment, the motion trajectory of the user and the motion trajectory of the person are simultaneously displayed on the image.

In one embodiment, the operation method further comprises the following steps: sensing a sound sent by the user by a sound sensor of the HMD device to generate sound data to the processor; and performing voice recognition to the sound data to obtain a sound control instruction by the processor.

In one embodiment, the operation method further comprises the following steps: sensing a touch operation of the user by a touch sensor of the HMD device to generate touch data to the processor; and generating a touch instruction by the processor according to the touch data.

In one embodiment, the operation method further comprises the following step: sensing a head motion of the user by a second motion sensor of the HMD device to generate second sensing data to the processor.

In one embodiment, the second motion sensor comprises an electronic compass, a gyroscope, a geomagnetic sensor, an accelerometer, or a g-sensor.

In one embodiment, the operation method further comprises the following step: generating a menu instruction by the processor according to the second sensing data.

In one embodiment, the operation method further comprises the following step: correcting the motion trajectory of the person by the processor according to a direction of the person in the video data.

According to the above descriptions, the user is capable of photographing a person in the view field of the user by using the head-mounted display device, and is capable of viewing the motion trajectory of the user or the motion trajectory of the person displayed by the head-mounted display device. Therefore, the user is unnecessary to hold a monitor by hand, such that the motion of the user is not interfered.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of a display system according to an embodiment of the invention.

FIG. 2 is a top view of a head-mounted display (HMD) device of FIG. 1 according to an embodiment of the invention.

FIG. 3 is a circuit block schematic diagram of the HMD device of FIG. 1 and FIG. 2 according to an embodiment of the invention.

FIG. 4 is a flowchart illustrating an operation method of the HMD device according to an embodiment of the invention.

FIG. 5 is a schematic diagram of a motion trajectory of a user obtained by a processor by analysing sensing data according to an embodiment of the invention.

FIG. 6 is a schematic diagram of a motion trajectory of a person obtained by a processor by performing image recognition according to an embodiment of the invention.

FIG. 7 is a schematic diagram of an image photographed by a camera when the person does not face the camera according to an embodiment of the invention.

FIG. 8 is a circuit block schematic diagram of the HMD device of FIG. 1 and FIG. 2 according to another embodiment of the invention.

FIG. 9 is a circuit block schematic diagram of the HMD device of FIG. 1 and FIG. 2 according to still another embodiment of the invention.

FIG. 10 is a circuit block schematic diagram of the HMD device of FIG. 1 and FIG. 2 according to yet another embodiment of the invention.

### DETAILED DESCRIPTION OF DISCLOSED EMBODIMENTS

The present invention will now be described more fully with reference to the accompanying drawings, in which exemplary embodiments of the invention are shown. The terms used herein such as “above,” “below,” “front,” “back,” “left” and “right” are for the purpose of describing directions in the figures only and are not intended to be limiting of the invention.

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

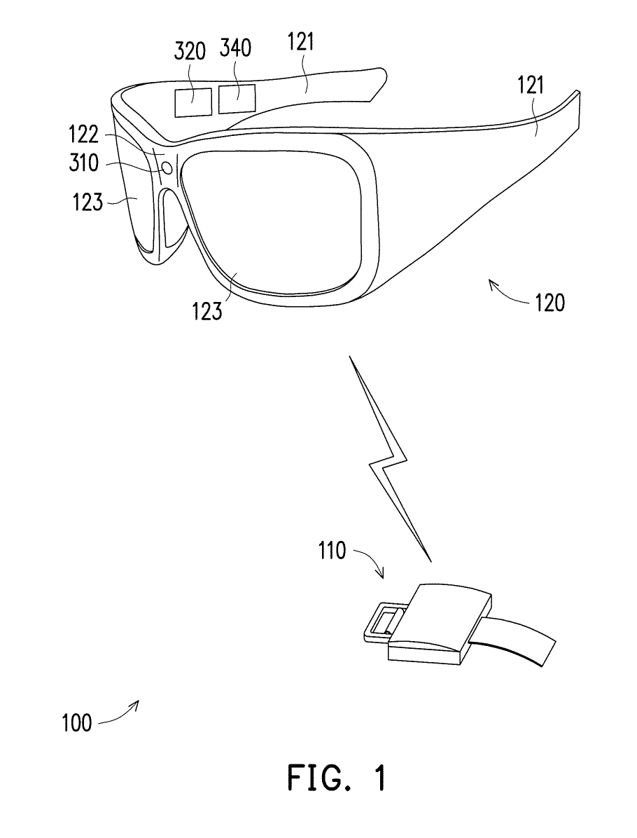

FIG. 1 is a three-dimensional view of a display system 100 according to an embodiment of the invention. The display system 100 includes one or a plurality of first motion sensors 110 and a head-mounted display (HMD) device 120. The first motion sensor 110 is adapted to be disposed on at least one of limbs (or a hand, an ail 1, a shoulder, a waist, a foot, or other body part) of a user of wearing the HMD device 120, or disposed on an object (for example, a golf club, a baseball bat, a tennis racket, or other object) held by the user. The first motion sensor 110 is, for example, a 6-axis sensor (which is adapted to sense a direction and an acceleration), which can be a g-sensor, a gyroscope, an accelerometer, an electronic compass, an altitude meter or other suitable motion sensor or a combination of the above sensors. The appearances of the first motion sensor 110 and the HMD device 120 shown in FIG. 1 are only an illustrative example. In other embodiment, the appearances of the first motion sensor 110 and the HMD device 120 may have other designs different to that of the appearances shown in FIG. 1.

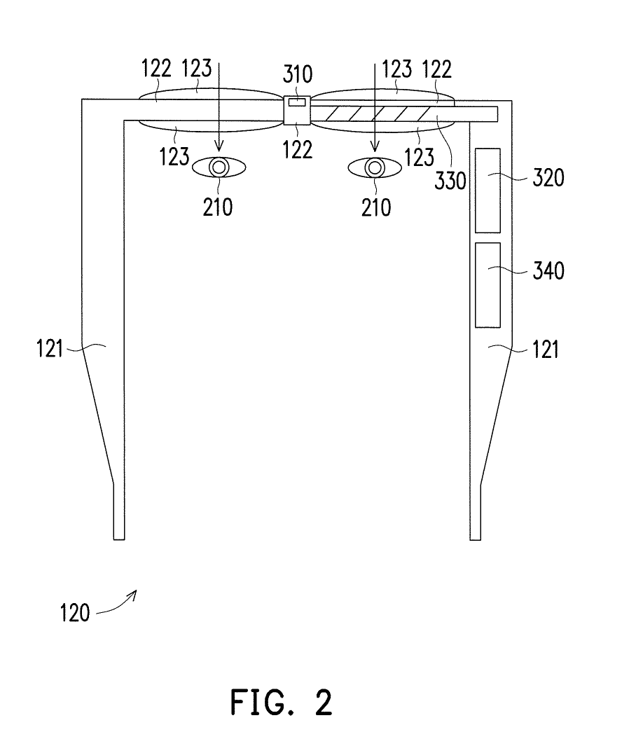

FIG. 2 is a top view of the HMD device 120 of FIG. 1 according to an embodiment of the invention. Referring to FIG. 1 and FIG. 2, the HMD device 120 is adapted to be worn on a head of the user. The HMD device 120 includes temples 121, a frame 122 and a monitor 330. The frame 122 is capable of accommodating lenses 123. Ambient light can be transmitted to eyes 210 of the user through the lenses 123 from the front of the HMD device 120. Therefore, the user can view front scenery through the HMD device 120. The monitor 330 can be configured on the frame 122 or other position of the HMD device 120 and located in a view field of the eye 210 of the user. In the embodiment of FIG. 2, the monitor 330 can be located in a right eye view field of the user, though the invention is not limited thereto. In other embodiments, the monitor 330 can also be located in a left eye view field of the user, or disposed in a binocular view field of the user. Therefore, the user can view an image displayed on the monitor 330. The monitor 330 can be a liquid crystal display (LCD), a light-emitting diode (LED) display, an organic light-emitting display (OLED), an electro-phoretic display (EPD), a micro projection display adopting a LED light source or a laser light source, a micro-electro-mechanical system (MEMS) mirror display or other displays, which is not limited by the invention.

A camera 310 is configured at a nose bridge of the frame 122 for photographing a person, such as recording motion of a person, in the view field of the user. The camera 310, for example, is a video camera capable of video recording. In other embodiments, according to a product design requirement, the camera 310 can be disposed on the temple 121 of the HMD device 120 or other suitable position. The HMD device 120 further includes a processor 320 and a communication circuit 340, where the processor 320 is, for example, a central processing unit (CPU) with a single core or multi-core, or other programmable general purpose or special purpose microprocessor, digital signal processor (DSP), programmable controller, application specific integrated circuit (ASIC) or other similar device or a combination of the above devices, which is not limited by the invention. The communication circuit 340 can establish a signal connection with the first motion sensor 110 through a cable medium (e.g., a general cable, an optical fiber, or other suitable cable connection method) or a wireless medium (e.g., Bluetooth, Wi-Fi, infrared, radio frequency communication or other suitable wireless connection method), which is not limited by the invention. For example, the communication circuit 340 can establish the signal connection with the first motion sensor 110 through a wireless sensor network (WSN) interface, a ZigBee network interface, a Bluetooth interface, an ANT+ network communication interface, a wireless local network (for example, a Wi-Fi network, etc.) interface, or other wireless communication interface. Therefore, the processor 320 can be connected to the first motion sensor 110 through the communication circuit 340.

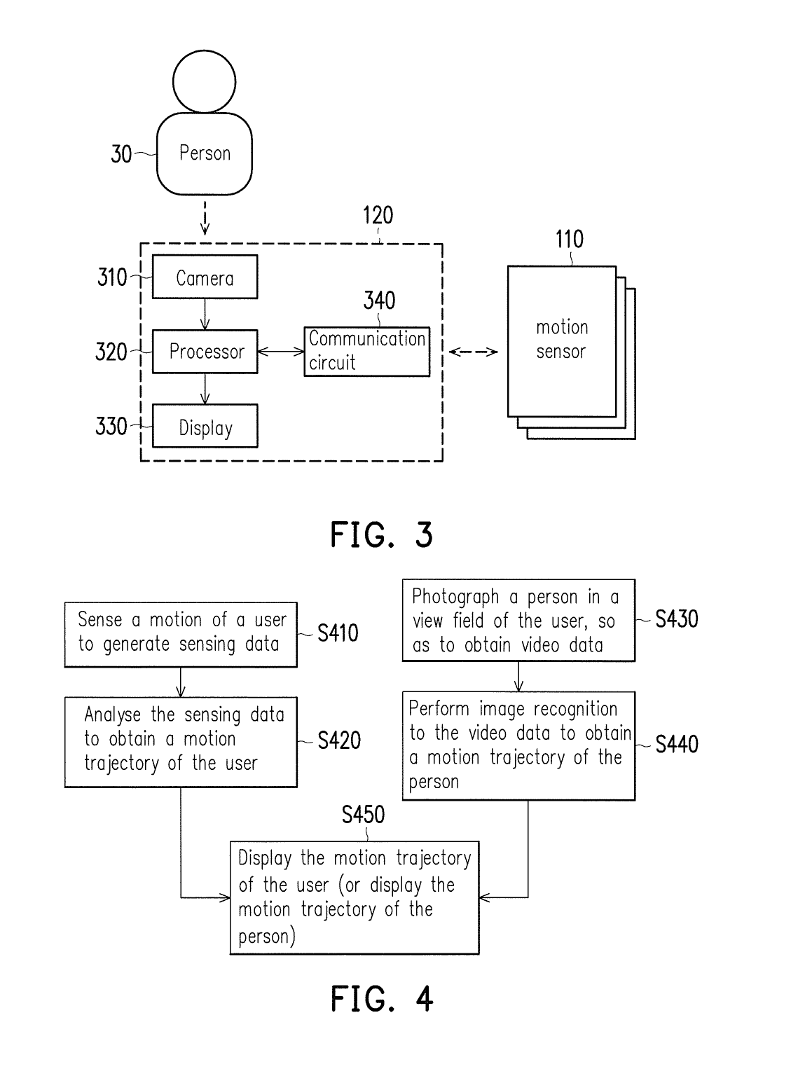

FIG. 3 is a circuit block schematic diagram of the HMD device 120 of FIG. 1 and FIG. 2 according to an embodiment of the invention. FIG. 4 is a flowchart illustrating an operation method of the HMD device 120 according to an embodiment of the invention. Referring to FIG. 1, FIG. 3 and FIG. 4, the HMD device 120 includes the camera 310, the processor 320, the monitor 330 and the communication circuit 340. The camera 310 is adapted to photograph a person 30 (e.g., recording motion of the person 30) in the view field of the user to generate video data. The monitor 330 is adapted to display an image for the user to view. The communication circuit 340 is adapted to connect the one or plurality of first motion sensors 110.

The processor 320 is coupled to the camera 310, the monitor 330 and the communication circuit 340. In step S410, the first motion sensor 110 senses a motion of the user to generate first sensing data. The processor 320 is connected to the first motion sensor 110 through the communication circuit 340. Therefore, the first sensing data generated by the first motion sensor 110 can be transmitted to the processor 320. In step S420, the processor 320 of the HMD device 120 analyzes the first sensing data generated by the first motion sensor 110 to obtain a motion trajectory of the user. In other embodiments, the motion trajectory of the user includes a motion trajectory of the object held by the user, a motion trajectory of at least one of limbs (e.g., a hand) of the user, or a motion trajectory of the other part of the body of the user.

In step S450, the processor 320 controls the monitor 330 of the HMD device 120, and displays the motion trajectory of the user in the image shown on the monitor 330. The user can view the motion trajectory displayed in the image to check/correct his motion or pose. Since the user can view his own motion trajectory through the HMD device 120, interference of user's motion is avoided (e.g., the user is unnecessary to hold the monitor by hand).

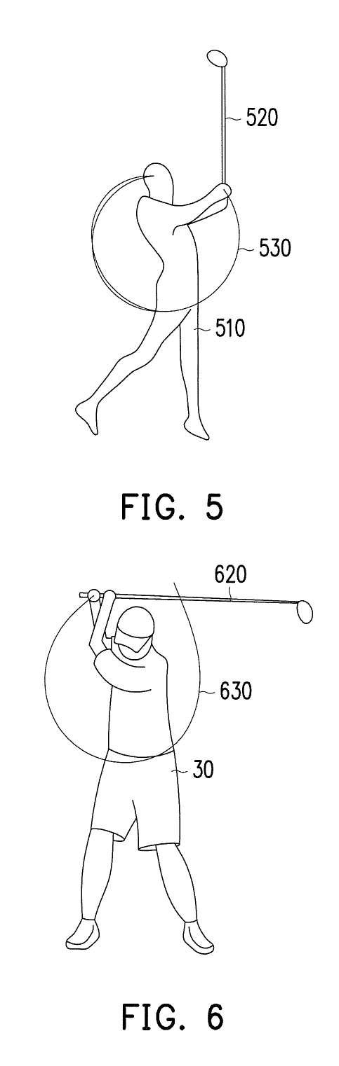

FIG. 5 is a schematic diagram of a motion trajectory of a user obtained by the processor 320 of the HMD device 120 by analysing the sensing data according to an embodiment of the invention. The first motion sensor 110 is, for example, disposed on the hand of a user 510 or on a golf club 520 held by the user 510. During a process that the user 510 swing the golf club 520, the communication circuit 340 transmits the first sensing data generated by the first motion sensor 110 to the processor 320. The processor 320 analyzes the first sensing data generated by the first motion sensor 110 to obtain a motion trajectory 530 of the user 510. In the present embodiment, the motion trajectory 530 can be a trajectory of the golf club 520 swung by the user 510. Therefore, in step 450, the motion trajectory 530 of the user 510 can be displayed in the image shown on the monitor 330.

In the embodiments of the invention, the first motion sensor 110 senses a motion of the user (for example, a golf practicer), and the HMD device 120 can present a swing curve of the user via the monitor 330. Therefore, the user is unnecessary to stop his motion and take out the monitor or a watch from a pocket or waist in order to view whether his swing motion is standard or correct, but can directly view his own motion trajectory 530 through the monitor 330 of the HMD device 120.

Referring to FIG. 1, FIG. 3 and FIG. 4, in another embodiment, in step S430, the camera 310 of the HMD device 120 photographs the person 30 (e.g., records motion of the person) in the view field of the user, so as to provide video data and transmit the same to the processor 320. Therefore, in step S430, the processor 320 can receive the video data provided by the camera 310. In step S440, the processor 320 performs image recognition to the video data generated by the camera 310 to obtain a motion trajectory of the person 30. In other embodiments, the motion trajectory of the person 30 includes a motion trajectory of an object held by the person 30, a motion trajectory of at least one of limbs (e.g., hand) of the person 30, or a motion trajectory of other body part of the person 30, though the invention is not limited thereto.

In step S450, the processor 320 controls the monitor 330 to display the motion trajectory of the person 30 in the image shown on the monitor 330. The user can view the motion trajectory of the person 30 displayed in the image to correct his own motion or pose.

FIG. 6 is a schematic diagram of a motion trajectory of the person 30 obtained by the processor 320 by performing the image recognition according to an embodiment of the invention. In the present embodiment, during a process that the person 30 swings a golf club 620, the camera 310 photographs the person 30 (e.g., records motion of the person) and transmits the video data to the processor 320. The processor 320 can perform the image recognition to the video data generated by the camera 310 to obtain a motion trajectory 630 of the person 30. In the present embodiment, the motion trajectory 630 can be a trajectory of the golf club 320 swung by the person 30. Therefore, in the step S450, the motion trajectory 630 of the person 30 can be displayed in the image shown on the monitor 330.

The HMD device 120 can use the inbuilt camera 310 to record the motion (for example, a swing motion of the other golf practicer) of the person 30. The processor 320 performs the image recognition (for example, performs swing motion analysis) to the video data generated by the camera 310. For example, the processor 320 can perform the image recognition to the video data generated by the camera 310 to obtain a body rotation motion, a knee bending motion, a hand bending motion, etc. of the person 30.

It should be noticed that the image shown on the monitor 330 can display the motion trajectory 530 of the user 510 shown in FIG. 5 or the motion trajectory 630 of the person 30 shown in FIG. 6. For example, in some embodiments, the image of the monitor 330 can selectively display the motion trajectory 530 of the user 510 shown in FIG. 5 or the motion trajectory 630 of the person 30 shown in FIG. 6. In another embodiment, the motion trajectory 530 of the user 510 shown in FIG. 5 and the motion trajectory 630 of the person 30 shown in FIG. 6 can be simultaneously displayed in the image shown on the monitor 330 for the user to compare his own motion trajectory 530 with the motion trajectory 630 of the person 30. Therefore, the user can check/correct his own motion or pose by viewing the image shown on the monitor 330.

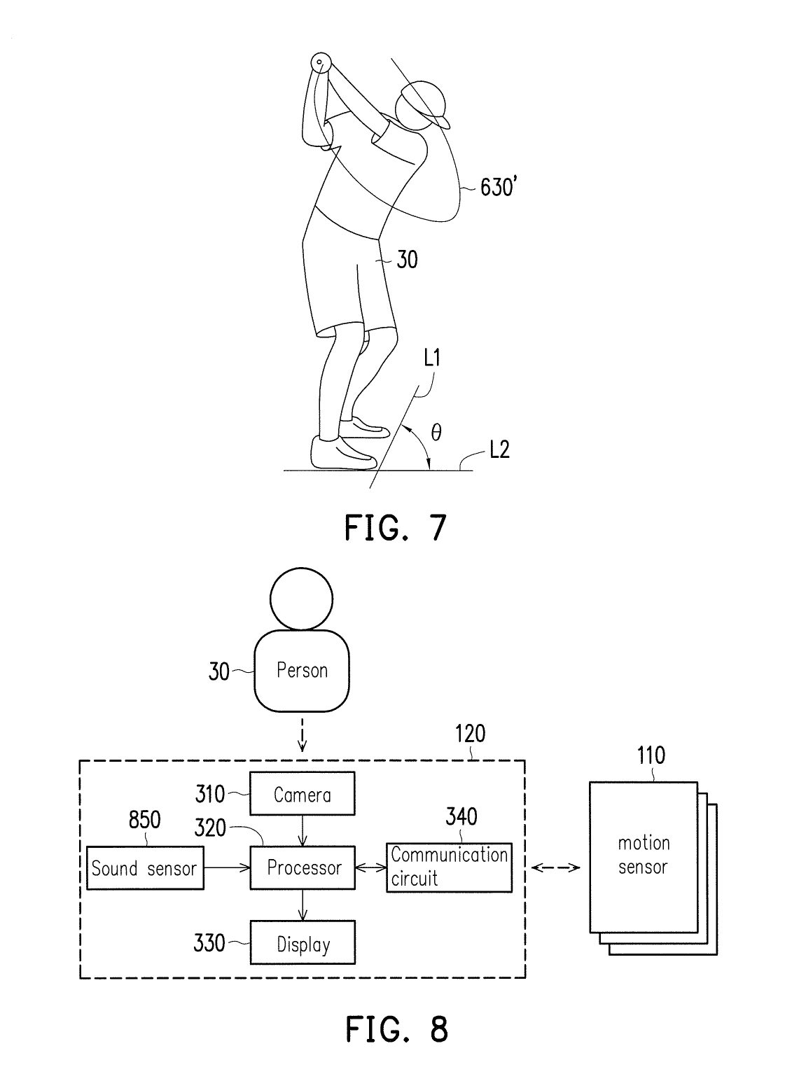

FIG. 7 is a schematic diagram of an image photographed by the camera 310 when the person 30 does not face the camera 310 according to an embodiment of the invention. When the person 30 does not face the camera 310, the processor 320 performs the image recognition to the video data (for example, the image shown in FIG. 7) generated by the camera 310, and obtains a motion trajectory 630′ of the person 30. Obviously, the motion trajectory 630′ is deformed due to a shooting angle of the camera 310. If the deformed motion trajectory 630′ is directly presented to the user, it probably causes confusion. In the present embodiment, the processor 320 can correct the motion trajectory 630′ of the person 30 according to a direction of the person 30 in the video data. For example, the processor 320 can perform the image recognition to obtain an included angle θ between a connection line L1 of two foot tips and a horizontal reference line L2, and take the included angle θ as the direction of the person 30. In this way, the processor 320 can correct the motion trajectory 630′ of the person 30 to the motion trajectory 630 shown in FIG. 6 according to the included angle θ and a trigonometric principle.

Implementation of the HMD device 120 of the invention is not limited to the implementation shown in FIG. 3. FIG. 8 is a circuit block schematic diagram of the HMD device 120 of FIG. 1 and FIG. 2 according to another embodiment of the invention. In the present embodiment, the HMD device 120 includes the camera 310, the processor 320, the monitor 330, the communication circuit 340 and a sound sensor 850. The camera 310, the processor 320, the monitor 330 and the communication circuit 340 shown in FIG. 8 can be referred to related descriptions of FIG. 3 to FIG. 7, and details thereof are not repeated.

The sound sensor 850 is, for example, a microphone or other electronic element having a sound receiving function. The sound sensor 850 is coupled to the processor 320, and is adapted to sense a sound sent by the user, so as to generate sound data to the processor 320. The processor 320 performs voice recognition to the sound data to obtain a sound control instruction. In some embodiments, the sound sensor 850 can serve as an input device for a menu operation of the HMD device 120. For example, the user can send a voice instruction (for example, the user can speak “up,” “down,” “left,” “right”) to perform a menu operation to a function menu displayed on the monitor 330.

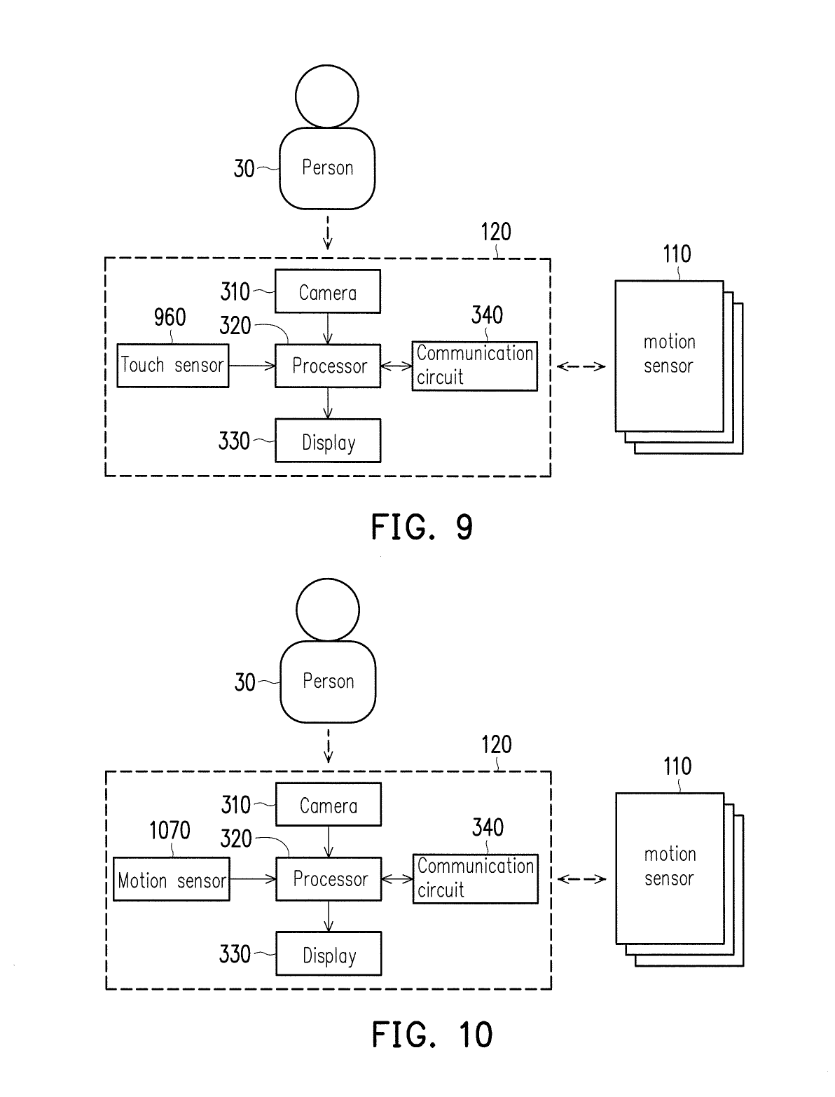

FIG. 9 is a circuit block schematic diagram of the HMD device 120 of FIG. 1 and FIG. 2 according to still another embodiment of the invention. The HMD device 120 includes the camera 310, the processor 320, the monitor 330, the communication circuit 340 and a touch sensor 960. The camera 310, the processor 320, the monitor 330 and the communication circuit 340 shown in FIG. 9 can be referred to related descriptions of FIG. 3 to FIG. 7, and details thereof are not repeated.

The touch sensor 960 of FIG. 9 is, for example, a touch panel or other electronic elements having a touch sensing function. The touch sensor 960 is coupled to the processor 320 and is adapted to sense a touch operation of the user, so as to generate touch data to the processor 320. The processor 320 generates a touch instruction according to the touch data. In some embodiments, the touch sensor 960 can serve as an input device for a menu operation of the HMD device 120. For example, the user's finger can slide upward, downward, leftward and rightward on the touch sensor 960 to perform the menu operation to the function menu displayed on the monitor 330.

FIG. 10 is a circuit block schematic diagram of the HMD device 120 of FIG. 1 and FIG. 2 according to yet another embodiment of the invention. The HMD device 120 includes the camera 310, the processor 320, the monitor 330, the communication circuit 340 and a second motion sensor 1070. The camera 310, the processor 320, the monitor 330 and the communication circuit 340 shown in FIG. 9 can be referred to related descriptions of FIG. 3 to FIG. 7, and details thereof are not repeated.

The second motion sensor 1070 is coupled to the processor 320. The second motion sensor 1070 is adapted to sense a head motion of the user, so as to generate second sensing data to the processor 320. In other embodiments, the second motion sensor 1070 can be an electronic compass, a gyroscope, a geomagnetic sensor, an accelerometer, a g-sensor, or other suitable motion sensor or a combination of the above sensors. The processor 320 generates a menu instruction according to the second sensing data generated by the second motion sensor 1070. Therefore, the second motion sensor 1070 can serve as an input device for a menu operation of the HMD device 120. The user wearing the HMD device 120 can perform the menu operation to the function menu displayed on the monitor 330 through head rotation (for example, up, down, left, right).

For example, after the user wears the HMD device 120, the user executes a start motion (for example, through a voice or a touch, etc.), which represents input of “a reset instruction.” The HMD device 120 can use a sound sensor (for example, the sound sensor 850 of FIG. 8) and/or a touch sensor (for example, the touch sensor 960 of FIG. 9) to sense the above start motion. After the reset operation is performed, the HMD device 120 can receive an instruction of the user to the menu operation. When the user turns his head (for example, upward, downward, leftward or rightward) by a threshold angle (for example, about 30 degrees) and holds the pose by a threshold time (for example, 2 seconds), the processor 320 confirms that the user inputs “a direction instruction.” For example, when the user's head turns to the left and holds the pose by 2 seconds, the processor 320 determines that the user sends a “turn left” instruction. Similarly, the user can perform the menu operation to the function menu displayed on the monitor 330 by turning the head upward, downward, leftward and rightward. When the user wants to execute an “enter” or “cancel” instruction, the user can additionally set a continuous motion on the HMD device 120, for example, a continuous nodding motion or continuous shaking motion. In another example, the processor 320 can present/display a ring or arc-distributed menu on the monitor 330. The HMD device 120 can use the second motion sensor 1070 as a menu operation device, such that when the user (for example, the golf practicer) turns his head, different menus can be displayed for the user to select according to different directions of the HMD device 120.

In summary, by disposing at least one first motion sensor on the user's body, one of limbs (e.g., hand) or an object held by the user, the HMD device can sense the motion trajectory of the user. When the user performs a motion, the first motion sensor can sense the motion of the user and transmits a corresponding signal to the processor of the HMD device. After the computation of the processor, the monitor can present the motion trajectory of the user in the image for the user to view. Moreover, the camera can photograph a person in the view field of the user. When the user views a motion of the others (the person) through the HMD device, the camera is adapted to photograph the motion of the person and transmit the same to the processor. After the computation of the processor, the HMD device can present the motion trajectory of the person for the user to view. In this way, the user is unnecessary to hold a monitor by hand, such that the motion of the user is not interfered.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention,” “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system, comprising:
a first motion sensor, adapted to be disposed on at least one of limbs of a user or on an object held by the user; and
a head-mounted display (HMD) device, adapted to be worn on a head of the user, and the HMD device comprising:
a camera, adapted to photograph a person in a view field of the user to generate video data;
a monitor, adapted to display an image for the user to view;
a communication circuit, adapted to establish connection with the first motion sensor; and
a processor, coupled to the monitor, the camera and the communication circuit, wherein the processor is adapted to receive and process first sensing data provided by the first motion sensor through the communication circuit, so as to obtain a motion trajectory of the user, and the processor is adapted to receive the video data provided by the camera, and perform image recognition to the video data to obtain a motion trajectory of the person, and display the motion trajectory of the user or the motion trajectory of the person on the image.

2. The display system as claimed in claim 1, wherein the motion trajectory of the user comprises a motion trajectory of the least one of limbs of the user or a motion trajectory of the object held by the user, and the motion trajectory of the person comprises a motion trajectory of at least one of limbs of the person or a motion trajectory of another object held by the person.

3. The display system as claimed in claim 1, wherein the first motion sensor comprises a g-sensor, a gyroscope, an accelerometer, an electronic compass, or an altitude meter.

4. The display system as claimed in claim 1, wherein the motion trajectory of the user and the motion trajectory of the person are simultaneously displayed on the image.

5. The display system as claimed in claim 1, wherein the HMD device comprises:
a sound sensor, coupled to the processor, and adapted to sense a sound sent by the user to generate sound data to the processor,
wherein the processor is adapted to perform voice recognition to the sound data to obtain a sound control instruction.

6. The display system as claimed in claim 1, wherein the HMD device comprises:
a touch sensor, coupled to the processor, and adapted to sense a touch operation of the user to generate touch data to the processor, wherein the processor is adapted to generate a touch instruction according to the touch data.

7. The display system as claimed in claim 1, wherein the HMD device comprises:
a second motion sensor, coupled to the processor, and adapted to sense a head motion of the user to generate second sensing data to the processor.

8. The display system as claimed in claim 7, wherein the second motion sensor comprises an electronic compass, a gyroscope, a geomagnetic sensor, an accelerometer, or a g-sensor.

9. The display system as claimed in claim 7, wherein the processor is adapted to generate a menu instruction according to the second sensing data.

10. The display system as claimed in claim 1, wherein the processor is adapted to correct the motion trajectory of the person according to a direction of the person in the video data.

11. An operation method of a display system, comprising:
sensing a motion of a user to generate first sensing data by a first motion sensor;
analyzing the first sensing data transmitted to a processor of a head-mounted display (HMD) device from the first motion sensor by the processor to obtain a motion trajectory of the user;
photographing a person in a view field of the user by a camera of the HMD device to provide video data and transmit the video data to the processor;
performing image recognition to the video data to obtain a motion trajectory of the person by the processor; and
displaying the motion trajectory of the user or the motion trajectory of the person on an image by a monitor of the HMD device.

12. The operation method of the display system as claimed in claim 11, wherein the HMD device is adapted to be worn on a head of the user, the first motion sensor is adapted to be disposed on at least one of limbs of the user or on an object held by the user, and the motion trajectory of the user comprises a motion trajectory of the least one of limbs of the user or a motion trajectory of the object held by the user.

13. The operation method of the display system as claimed in claim 11, wherein the motion trajectory of the person comprises a motion trajectory of at least one of limbs of the person or a motion trajectory of another object held by the person.

14. The operation method of the display system as claimed in claim 11, wherein the first motion sensor comprises a g-sensor, a gyroscope, an accelerometer, an electronic compass, or an altitude meter.

15. The operation method of the display system as claimed in claim 11, wherein the motion trajectory of the user and the motion trajectory of the person are simultaneously displayed on the image.

16. The operation method of the display system as claimed in claim 11, further comprising:
sensing a sound sent by the user by a sound sensor of the HMD device to generate sound data to the processor; and
performing voice recognition to the sound data to obtain a sound control instruction by the processor.

17. The operation method of the display system as claimed in claim 11, further comprising:
sensing a touch operation of the user by a touch sensor of the HMD device to generate touch data to the processor; and
generating a touch instruction by the processor according to the touch data.

18. The operation method of the display system as claimed in claim 11, further comprising:
sensing a head motion of the user by a second motion sensor of the HMD device to generate second sensing data to the processor.

19. The operation method of the display system as claimed in claim 18, wherein the second motion sensor comprises an electronic compass, a gyroscope, a geomagnetic sensor, an accelerometer, or a g-sensor.

20. The operation method of the display system as claimed in claim 18, further comprising:
generating a menu instruction by the processor according to the second sensing data.

21. The operation method of the display system as claimed in claim 11, further comprising:
correcting the motion trajectory of the person by the processor according to a direction of the person in the video data.
